(19) United States
(12) Patent Application Publication
(10) Pub. No.: US 2003/0154219 A1
(43) Pub. Date: Aug. 14, 2003

(54) Information processing system, information processing apparatus and method, and program

(75) Inventors: Midori Yoshihara, Tokyo (JP); Tsuyoshi Arai, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/351,475

(22) Filed: Jan. 27, 2003

(30) Foreign Application Priority Data
Jan. 29, 2002 (JP) 2002-020291

(51) Int. Cl. G06F 12/00

(52) U.S. Cl. 707/203

(57) ABSTRACT

A personal computer is disclosed which acquires necessary information from a Web server in order to acquire an installer for various pieces of software. In response to a request from the personal computer, the Web server acquires information necessary to acquire the installer from a database server and supplies the information to the personal computer. The database server manages information necessary to acquire the installer and supplies the information to the Web server in accordance with the request. With this configuration, a file server stores an installer for software to be installed into the personal computer and so forth.

### BACKGROUND OF THE INVENTION

This invention relates to an information processing system, an information processing apparatus and method, and a program, and more particularly to an information processing system, an information processing apparatus and method, and a program by which software of a necessary version can be installed appropriately.

In order to make it possible to use, for example, a personal computer purchased, it is sometimes required to install software such as an OS (Operating System), a BIOS (Basic Input/Output System) or application software.

For example, application software is sometimes recorded on and provided as a CD-ROM packed commonly with the product. In this instance, the user will read the personal computer to read the CD-ROM to install the application software into the personal computer.

However, where software is recorded on and provided as a CD-ROM in this manner, if version up of the software is performed later, the user must install the software of the old version.

Therefore, a service of providing an installer for the software of the new version through communication so that the software of the new version may be installed is available. However, according to conventional services, the user cannot select the software to be installed for different applications.

Further, it is sometimes desired to return the version of the software installed already to that when the product was purchased. However, according to conventional services, it is impossible to arbitrarily select a version (select an old version) to be installed.

In short, the conventional services have a subject to be solved in that software of a necessary version can be installed appropriately.

### SUMMARY OF THE INVENTION

It is an object of the present invention to provide an information processing system, an information processing apparatus and method and a program by which software of a necessary version can be acquired appropriately.

In order to attain the object described above, according to an aspect of the present invention, there is provided an information processing system, including a management server, a software information server, a terminal, an install information server, and a network for interconnecting the management server, software information server, terminal and install information server; the management server including first transmission means for acquiring apparatus information of the terminal and transmitting the apparatus information to the software information server, second transmission means for producing, based on first software information, transmitted from the software information server, of software corresponding to the apparatus information transmitted by the first transmission means, first designation information for designating the software and transmitting the first designation information to the terminal, third transmission means for transmitting the first software information of the software designated based on the first designation information by the terminal to the software information server, and fourth transmission means for transmitting second software information, transmitted from the software information server, of the software corresponding to the first software information transmitted by the third transmission means; the software information server including first storage means for storing the first software information in a matched relationship with the apparatus information and storing the second software information in a matched relationship with part or the entirety of the first software information, first search means for searching the first storage means for the first software information matched with the apparatus information transmitted by the first transmission means of the management server, fifth transmission means for transmitting the first software information searched out by the first search means to the management server, second search means for searching the first storage means for the second software information matched with the first software information transmitted by the third transmission means of the management server, and sixth transmission means for transmitting the second software information searched out by the second search means to the management server; the terminal including first designation means for designating the software based on the first designation information transmitted from the second transmission means of the management server, requesting means for requesting install information corresponding to the second software information transmitted by the fourth transmission means of the management server to the install information server, and install means for installing the software based on the install information transmitted from the install information server in response to the request from the requesting means; the install information server including second storage means for storing the install information in a matched relationship with part or the entirety of the second software information, third search means for searching the second search means for the install information of the object of the request from the requesting means of the terminal, and seventh transmission means for transmitting the install information searched out by the third search means to the terminal.

In the information processing system, the management server acquires apparatus information of the terminal from the terminal and transmits the apparatus information to the software information server. Further, the management server produces, based on first software information, transmitted from the software information server, of software corresponding to the apparatus information transmitted therefrom, first designation information for designating the software and transmits the first designation information to the terminal. Furthermore, the management server transmits the first software information of the software designated based on the first designation information by the terminal to the software information server, and transmits second software information, transmitted from the software information server, of the software corresponding to the first software information transmitted therefrom. The software information server stores the first software information in a matched relationship with the apparatus information and stores the second software information in a matched relationship with part or the entirety of the first software information. Further, the software information server searches for the first software information matched with the apparatus information transmitted thereto, and transmits the first software information thus searched out to the management server. Furthermore, the software information server searches for the second software information matched with the first software information transmitted thereto, and transmits the second software information thus searched out to the management server. The terminal designates the software based on the first designation information transmitted thereto, and installs the software based on the install information transmitted thereto in response to the request therefrom. The install information server stores the install information in a matched relationship with part or the entirety of the second software information, and searches for the install information of the object of the request and transmits the install information thus searched out to the terminal. Consequently, software of a necessary version can be installed appropriately.

According to another aspect of the present invention, there is provided an information processing apparatus, including a terminal into which software is to be installed, a server for managing information regarding the software, first transmission means for acquiring apparatus information of the terminal from the terminal and transmitting the apparatus information to the server, second transmission means for producing, based on first software information, transmitted from the server, of the software corresponding to the apparatus information transmitted by the first transmission means, designation information for designating the software, the first software information including identification information of the software, and transmitting the designation information to the terminal, third transmission means for transmitting the first software information of the software designated based on the designation information by the terminal to the server, and fourth transmission means for transmitting second software information transmitted from the server and corresponding to the first software information transmitted by the third transmission means to the terminal, the second software information including information representative of a place at which information for installing the software exists.

According to a further aspect of the present invention, there is provided an information processing method, including a first transmission step of acquiring, from a terminal into which software is to be installed, apparatus information of the terminal and transmitting the apparatus information to a server which manages information regarding the software, a second transmission step of producing, based on first software information, transmitted from the server, of the software corresponding to the apparatus information transmitted by the process at the first transmission step, designation information for designating the software, the first software information including identification information of the software, and transmitting the designation information to the terminal, a third transmission step of transmitting the first software information of the software designated based on the designation information by the terminal to the server, and a fourth transmission step of transmitting second software information transmitted from the server and corresponding to the first software information transmitted by the process at the third transmission step to the terminal, the second software information including information representative of a place at which information for installing the software exists.

According to a still further aspect of the present invention, there is provided a program for causing a computer to execute a process including a first transmission controlling step of controlling acquisition, from a terminal into which software is to be installed, of apparatus information of the terminal and transmission of the apparatus information to a server which manages information regarding the software, a second transmission controlling step of controlling production, based on first software information, transmitted from the server, of the software corresponding to the apparatus information transmitted by the process at the first transmission controlling step, of designation information for designating the software, the first software information including identification information of the software, and transmission of the designation information to the terminal, a third transmission controlling step of controlling transmission of the first software information of the software designated based on the designation information by the terminal to the server, and a fourth transmission controlling step of controlling transmission of second software information transmitted from the server and corresponding to the first software information transmitted by the process at the third transmission controlling step to the terminal, the second software information including information representative of a place at which information for installing the software exists.

In the information processing apparatus and method and the program, apparatus information of the terminal is acquired from the terminal and transmitted to the server. Then, based on first software information, transmitted from the server and including identification information of the software, of the software corresponding to the apparatus information, designation information for designating the software is produced and transmitted to the terminal. Further, the first software information of the software designated based on the designation information by the terminal is transmitted to the server, and second software information transmitted from the server and corresponding to the first software information is transmitted to the terminal. The second software information includes information representative of a place at which information for installing the software exists. Consequently, software of a necessary version can be installed appropriately.

According to a yet further aspect of the present invention, there is provided an information processing apparatus connectable to a terminal and a server through a network, including first storage means for storing first software information of software which can be installed by the terminal in a matched relationship with apparatus information of the terminal, the first software information including identification information of the software, and storing second software information of the software including information representative of a place at which information necessary for installing the software exists in a matched relationship with part or the entirety of the first software information, first search means for searching the first storage means for the first software information matched with the apparatus information transmitted from the server, first transmission means for transmitting the first software information searched out by the first search means to the server, second search means for searching the first storage means for the second software information matched with the first software information transmitted from the server, and second transmission means for transmitting the software information searched out by the second search means to the server so that the server may transmit the second software information to the server.

According to a yet further aspect of the present invention, there is provided an information processing method for an information processing apparatus connectable to a terminal and a server through a network, including a storage step of storing first software information of software which can be installed by the terminal in a matched relationship with apparatus information of the terminal, the first software information including identification information of the software, and storing second software information of the software including information representative of a place at which information necessary for installing the software exists in a matched relationship with part or the entirety of the first software information, a first search step of searching for the first software information matched with the apparatus information transmitted from the server from the storage step, a first transmission step of transmitting the first software information searched out by the process at the first search step to the server, a second search step of searching for the second software information matched with the first software information transmitted from the server from the storage step, and a second transmission step of transmitting the software information searched out by the process at the second search step to the server so that the server may transmit the second software information to the server.

According to a yet further aspect of the present invention, there is provided a program for an information processing apparatus connectable to a terminal and a server through a network, the program causing a computer to execute a process including a storage controlling step of controlling storage of first software information of software which can be installed by the terminal in a matched relationship with apparatus information of the terminal, the first software information including identification information of the software, and storage of second software information of the software including information representative of a place at which information necessary for installing the software exists in a matched relationship with part or the entirety of the first software information, a first search controlling step of controlling search for the first software information matched with the apparatus information transmitted from the server, a first transmission controlling step of controlling transmission of the first software information searched out by the process at the first search controlling step to the server, a second search controlling step of controlling search for the second software information matched with the first software information transmitted from the server, and a second transmission controlling step of controlling transmission of the second software information searched out by the process at the second search controlling step to the server so that the server may transmit the second software information to the server.

In the information processing apparatus and method and the program, first software information of software which can be installed by the terminal including identification information of the software is stored in a matched relationship with apparatus information of the terminal, and second software information of the software including information representative of a place at which information necessary for installing the software exists is stored in a matched relationship with part or the entirety of the first software information. Further, the first software information matched with the apparatus information transmitted from the server is searched for, and the first software information thus searched out is transmitted to the server. Furthermore, the second software information matched with the first software information transmitted from the server is searched for, and the software information thus searched out is transmitted to the server so that the server may transmit the second software information to the server. Consequently, software of a necessary version can be installed appropriately.

According to a yet further aspect of the present invention, there is provided an information processing apparatus connectable to a first server and a second server through a network, including designation means for designating, based on designation information transmitted from the first server for designating software corresponding to apparatus information of the information processing apparatus, the software, the designation information being produced based on first software information of the software including identification information of the software, requesting means for requesting install information indicated by second software information, transmitted from the first server, of the software designated by the designation means to the second server, and install means for installing the software based on the install information transmitted from the second server in response to the request of the requesting means.

According to a yet further aspect of the present invention, there is provided an information processing method for an information processing apparatus connectable to a first server and a second server through a network, including a designation step of designating, based on designation information transmitted from the first server for designating software corresponding to apparatus information of the information processing apparatus, the software, the designation information being produced based on first software information of the software including identification information of the software, a request step of requesting install information indicated by second software information, transmitted from the first server, of the software designated by the process at the designation step to the second server, and an install step of installing the software based on the install information transmitted from the second server in response to the request by the process at the request step.

According to a yet further aspect of the present invention, there is provided a program for an information processing apparatus connectable to a first server and a second server through a network, the program causing a computer to execute a processing including a designation controlling step of controlling designation, based on designation information transmitted from the first server for designating software corresponding to apparatus information of the information processing apparatus, of the software, the designation information being produced based on first software information of the software including identification information of the software, a request controlling step of controlling the request to the second server for install information indicated by second software information, transmitted from the first server, of the software designated by the process at the designation controlling step, and an install controlling step of controlling installation of the software based on the install information transmitted from the second server in response to the request by the process at the request controlling step.

In the information processing apparatus and method and the program, based on designation information transmitted from the first server for designating software corresponding to apparatus information of the information processing apparatus and produced based on first software information of the software including identification information of the software, the software is designated, and install information indicated by second software information, transmitted from the first server, of the software thus designated is requested to the second server. Then, the software is installed based on the install information transmitted from the second server in response to the request. Consequently, software of a necessary version can be installed appropriately.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing an example of connection of a software providing system to which the present invention is applied;

FIG. 2 is a block diagram showing an example of a configuration of a personal computer shown in FIG. 1;

FIG. 3 is a block diagram showing an example of a configuration of a Web server shown in FIG. 1;

FIG. 4 is a block diagram showing an example of a configuration of a database server shown in FIG. 1;

FIG. 5 is a block diagram showing an example of a configuration of a file server shown in FIG. 1;

FIGS. 6 and 7 are flow charts illustrating a processing procedure for displaying a list of software to be installed;

FIG. 8 is a schematic view showing an example of display of a type designation screen used in the software providing system of FIG. 1;

FIG. 9 is a view illustrating a configuration of data of a table used in the software providing system of FIG. 1;

FIG. 10 is a schematic view showing an example of a display of a package designation screen used in the software providing system of FIG. 1;

FIG. 11 is a view illustrating a configuration of data of another table used in the software providing system of FIG. 1;

FIG. 12 is a schematic view showing an example of a display of a software designation screen used in the software providing system of FIG. 1;

FIG. 13 is a view illustrating a configuration of data of a further table used in the software providing system of FIG. 1;

FIG. 14 is a view illustrating a configuration of data of a still further table used in the software providing system of FIG. 1;

FIG. 15 is a schematic view showing an example of a display of a confirmation screen used in the software providing system of FIG. 1;

FIG. 16 is a flow chart illustrating a processing procedure when software is installed in the software providing system of FIG. 1;

FIGS. 17 to 19 are schematic views showing different examples of a display of a confirmation screen used in the software providing system of FIG. 1;

FIG. 20 is a flow chart illustrating another processing procedure for displaying a list of software to be installed in the software providing system of FIG. 1;

FIG. 21 is a schematic view showing an example of display of a version designation screen used in the software providing system of FIG. 1; and

FIG. 22 is a view illustrating a configuration of data of a yet further table.

### DESCRIPTION OF THE PREFERRED EMBODIMENT

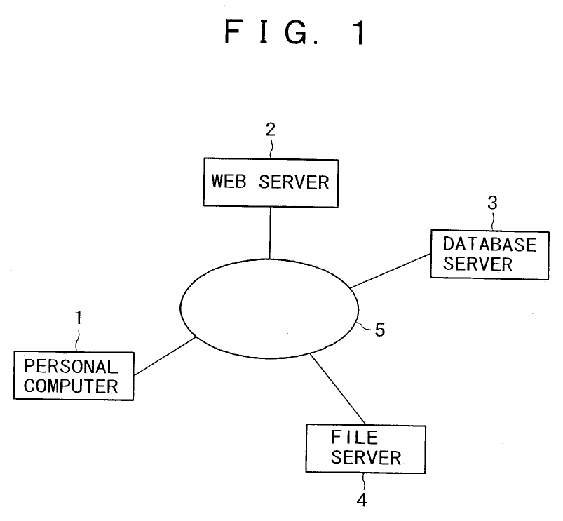

FIG. 1 shows an example of connection of a software providing system to which the present invention is applied. Referring to FIG. 1, a personal computer 1, a Web (World Wide Web) server 2, a database server 3 and a file server 4 are connected to the Internet 5.

The personal computer 1 uses the system to acquire an installer for installing several kinds of software (for example, software for an application, a BIOS and so forth) from the file server 4. Thereupon, the personal computer 1 acquires information necessary for acquiring the installer from the Web server 2.

The Web server 2 acquires, in response to a request from the personal computer 1, information necessary for acquiring an installer from the database server 3 and supplies the information to the personal computer 1.

The database server 3 manages information necessary for acquiring an installer in accordance with, for example, logic of a relational data model and supplies information to the Web server 2 in response to a request for it.

The file server 4 stores installers of software to be installed into the personal computer 1 and so forth and supplies a necessary installer to the personal computer 1 in response to a request for it.

It is to be noted that transfer of data between the personal computer 1 and the Web server 2 is performed in accordance with the HTTP (Hyper Text Transfer Protocol), and transfer of data between the personal computer 1 and the file server 4 is performed in accordance with the FTP (File Transfer Protocol). Further, data readout and so forth by the Web server 2 from the database server 3 are performed using the SQL (Structured Query Language).

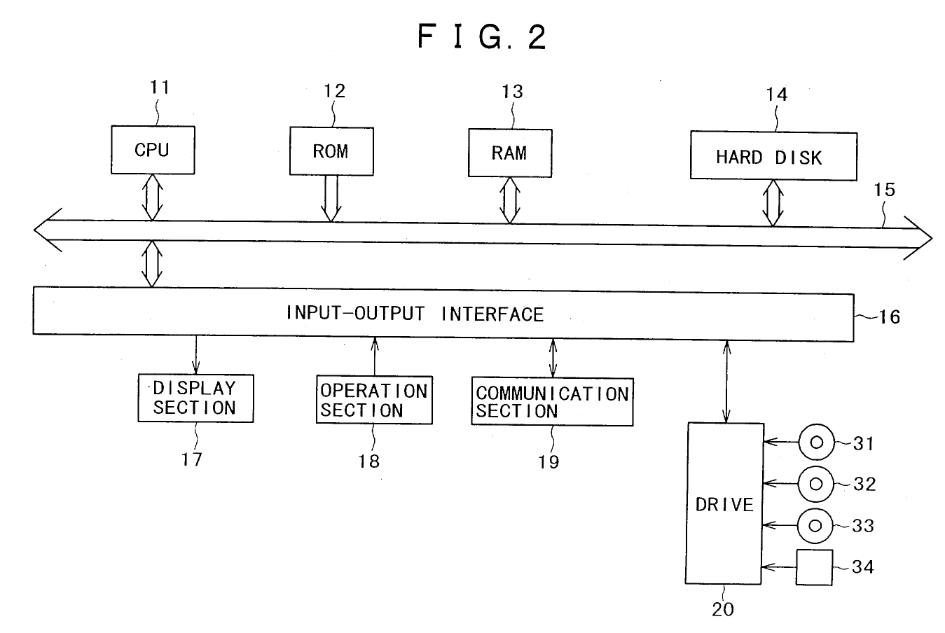

FIG. 2 shows an example of a configuration of the personal computer 1.

Referring to FIG. 2, an input/output interface 16 is connected to a CPU (Central Processing Unit) 11 through a bus 15. If an instruction from the user is inputted from an operation section 18 formed from a keyboard, a mouse and so forth, then the CPU 11 loads, for example, a program (such as, for example, a WWW browser) stored in a ROM (Read Only Memory) 12, a hard disk 14, or a recording medium such as a magnetic disk 31, an optical disk 32, a magneto-optical disk 33, a semiconductor memory 34 or the like loaded in a drive 20, into a RAM (Random Access Memory) 13 and executes the program.

Further, the CPU 11 outputs a result of the process just described when necessary to a display section 17 formed from an LCD (liquid Crystal Display) unit or the like, for example, through the input/output interface 16.

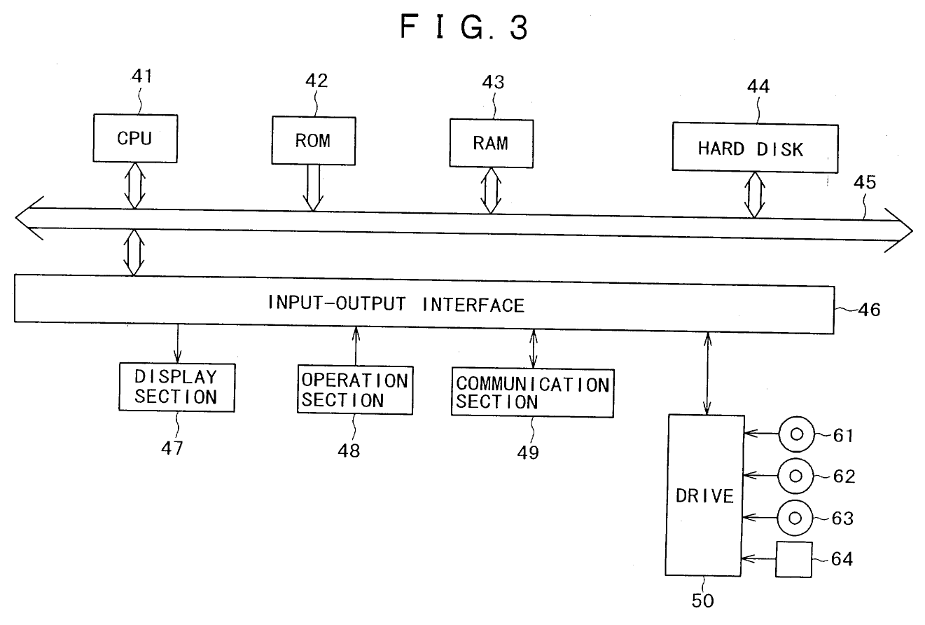

FIG. 3 shows an example of a configuration of the Web server 2. An input/output interface 46 is connected to a CPU 41 through a bus 45. If an instruction from the manager of the Web server 2 is inputted from an operation section 48 formed from a keyboard, a mouse or the like through the input/output interface 46, then the CPU 41 loads a program stored, for example, in a ROM 42, a hard disk 44, or a recording medium such as a magnetic disk 61, an optical disk 62, a magneto-optical disk 63, a semiconductor memory 64 or the like loaded in a drive 50, into a RAM 43 and executes the program.

Further, the CPU 41 outputs a result of the process just described when necessary to a display section 47 formed from an LCD unit or the like, for example, through the input/output interface 46.

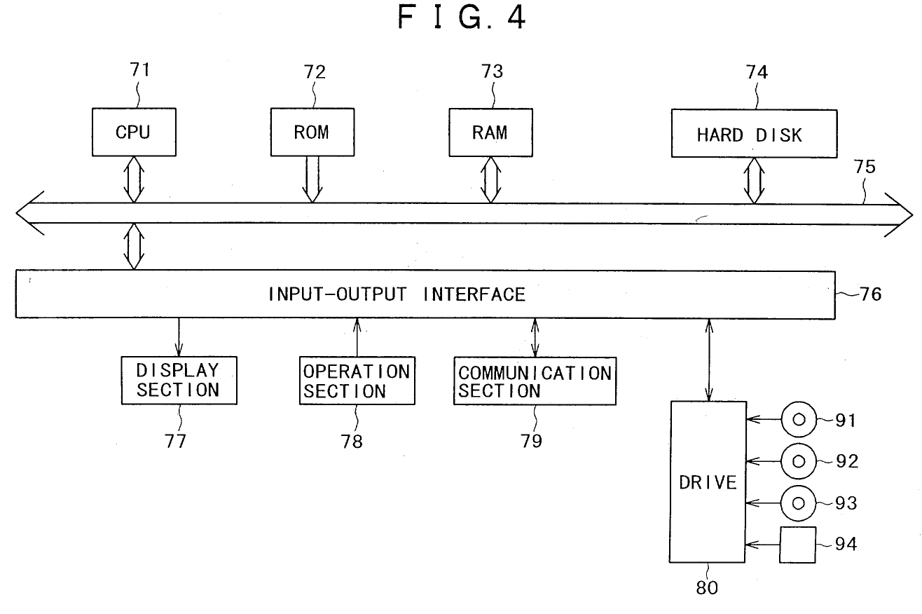

FIG. 4 shows an example of a configuration.of the database server 43. Since the configuration of the database server 43 is basically same as the configuration of the Web server 2, detailed description thereof is omitted herein to avoid redundancy. Information relating to application software to be installed into the personal computer 1 is stored in a hard disk 74.

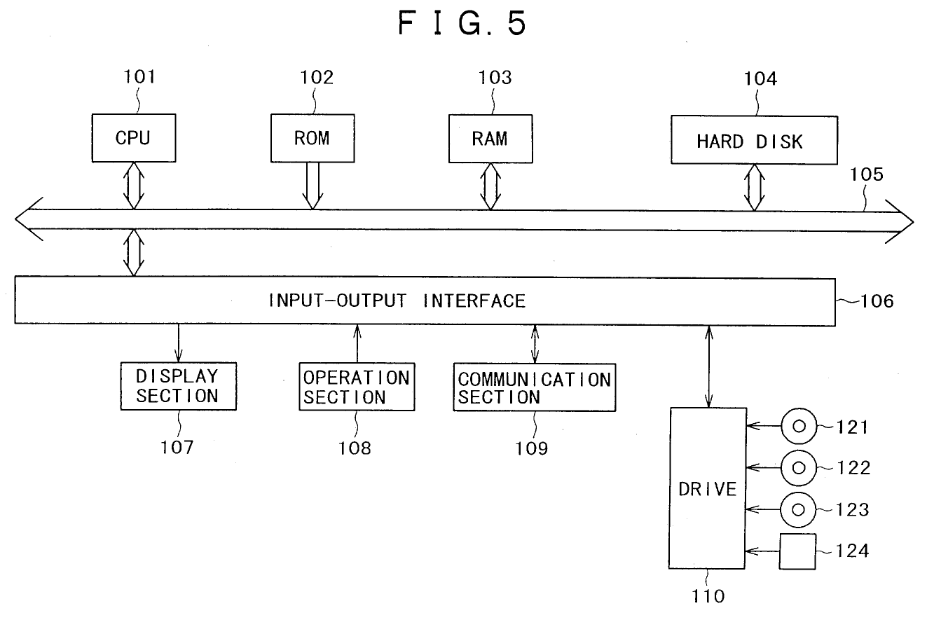

FIG. 5 shows an example of a configuration of the file server 4. Since the configuration of the file server 4 is basically same as the configuration of the Web server 2 or the database server 3, detailed description thereof is omitted herein to avoid redundancy. An installer for installing application software into the personal computer 1 and so forth are stored in a hard disk 104.

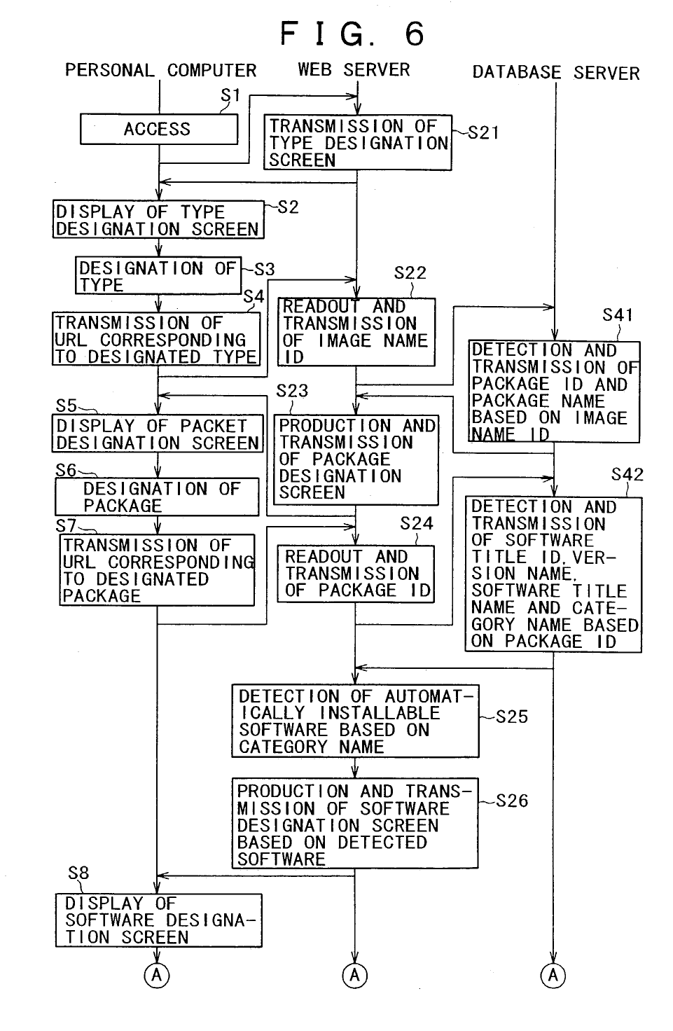

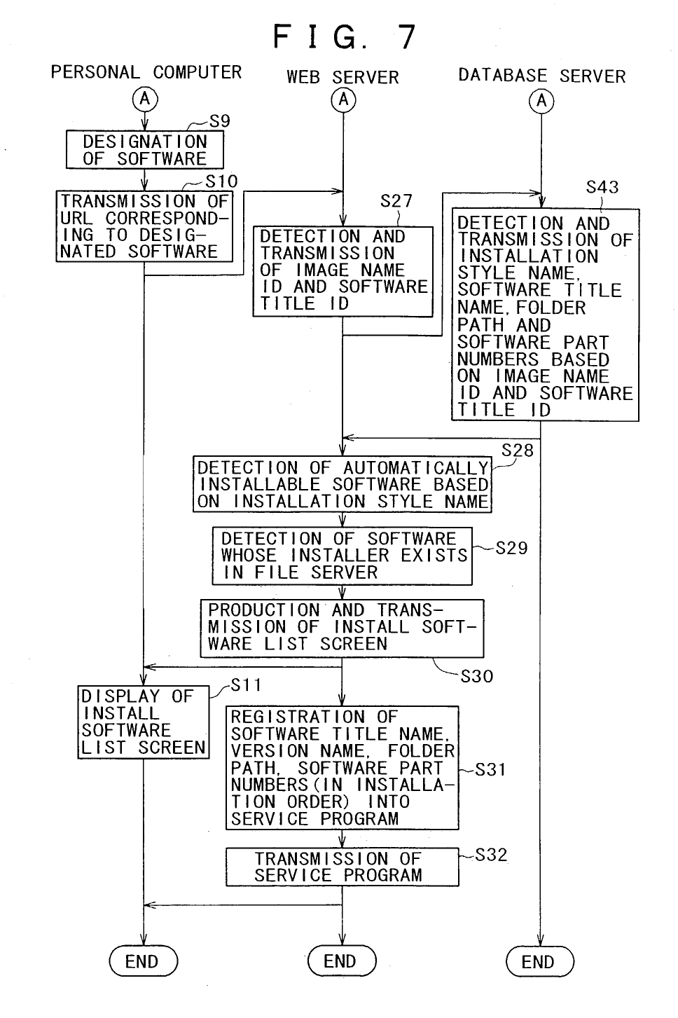

A processing procedure when software is installed into the personal computer 1 using the information processing system of the present embodiment is described below. First, a process until a list of software to be installed is displayed on the personal computer 1 is described with reference to flow charts of FIGS. 6 and 7.

If a Web browser is started up in the personal computer 1 and a predetermined URL is inputted by the user, then at step S1, the CPU (Web browser) 11 controls a communication section 19 to transfer a command of the HTTP for requesting data of a screen (hereinafter referred to as “type designation screen”) for designating a machine type to the Web server 2 through the Internet 5.

If the command from the personal computer 1 is received, then at step S21, the CPU 41 of the Web server 2 reads out data (data written in the HTML) of the type designation screen of a homepage designated by the command from the hard disk 44, and controls a communication section 49 to transmit the read out data to the personal computer 1.

At step S2, the CPU 11 of the personal computer 1 controls the display section 17 to display the type designation screen transmitted from the Web server 2 thereon.

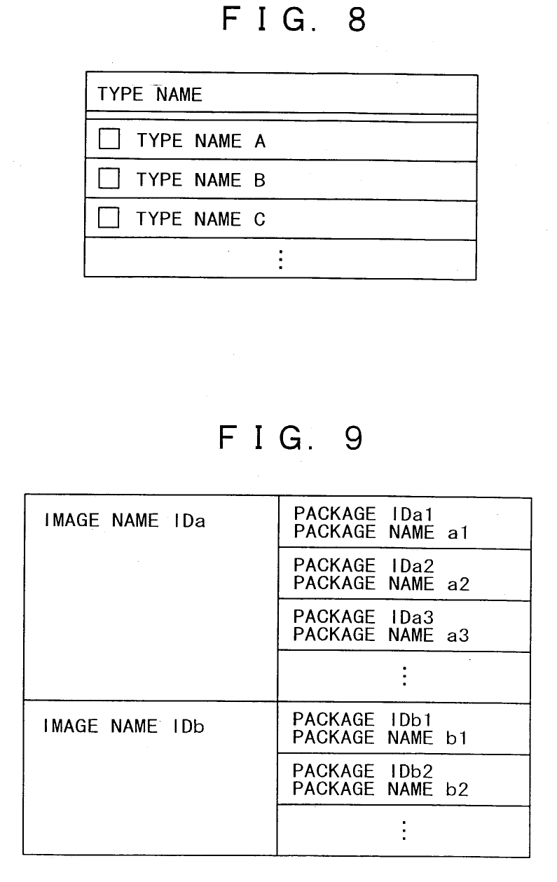

FIG. 8 shows an example of the type designation screen. On the type designation screen, the names of machine types (in the example shown, type names A, B and C) of apparatus into which software can be installed using the present system are displayed. It is to be noted that a URL is matched with each of the machine type names, and the Web server 2 stores an ID (image name ID) of the machine type in the homepage corresponding to the URL.

At step S3, if the user of the personal computer 1 operates the operation section 18 to operate a checkbox (in FIG. 8, a display of a square displayed corresponding to a machine type name) provided corresponding to each of the type names displayed on the type designation screen to designate a machine type name, then the CPU 11 of the personal computer 1 acquires a URL corresponding to the designated machine type name, and then at step S4, requests a package designation screen (hereinafter described) based on data of the homepage designated by the URL to the Web server 2.

The CPU 41 of the Web server 2 reads out, at step S22, an image name ID stored in the designated homepage in accordance with the request from the personal computer 1 and controls the communication section 49 to transmit the image name ID to the database server 3.

The CPU 71 of the database server 3 refers, at step S41, to a predetermined table (table 1) stored on the hard disk 74 to detect a package ID and a package name matched with the image name ID transmitted from the Web server 2.

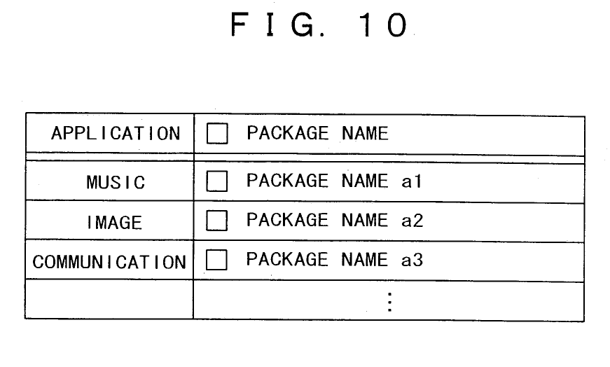

FIG. 9 shows an example of a configuration of the table 1. Referring to FIG. 9, in the table 1, a plurality of sets each including a package ID and a package name are matched with each image name ID (in the example of FIG. 9, image name IDa or IDb).

Here, the package ID is an ID allocated to each of different applications of the software. The package name is a name allocated to the set of pieces of the software for the application.

Referring back to FIG. 6, the CPU 71 of the database server 3 controls the communication section 79 to transmit the detected package ID and package name to the Web server 2.

The CPU 41 of the Web server 2 produces, at step S23, a package designation screen for designating a package based on the package ID and the package name received from the database server 3 and controls the communication section 49 to transmit the package designation screen to the personal computer 1.

At step S5, the CPU 11 of the personal computer 1 controls the display section 17 to display the package designation screen transmitted from the Web server 2.

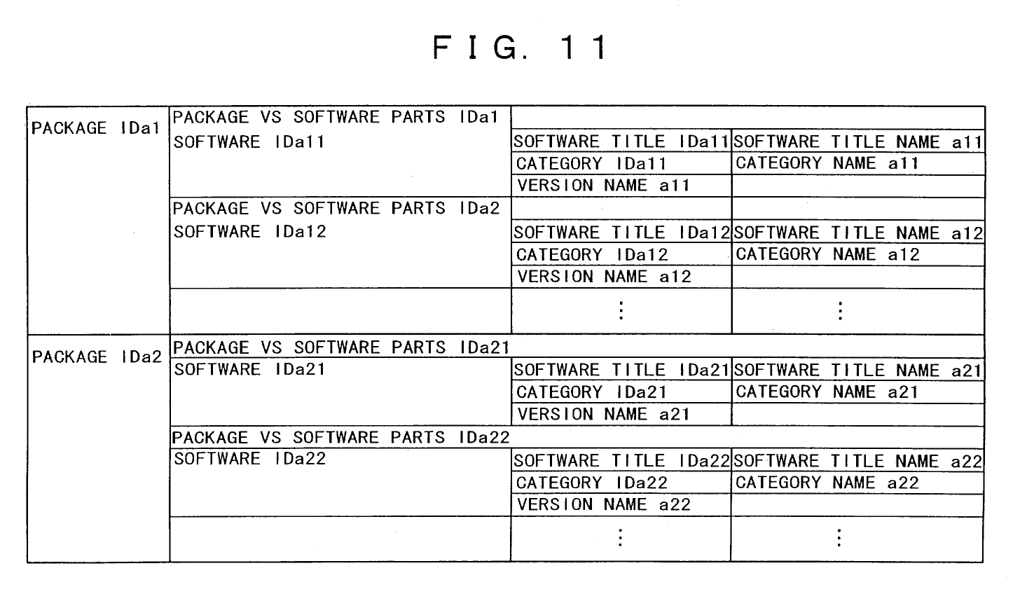

FIG. 10 shows an example of a display of the package designation screen. Referring to FIG. 10, on the screen shown, the names (package names) of packages (sets of pieces of software for the same applications) of software which can be installed into the machine type designated at step S2 are displayed. It is to be noted that a URL is matched with each package name, and the Web server 2 stores the following data in a homepage corresponding to the URL:

*image name ID,

*package ID, and

*package name.

In the example of FIG. 10, the name (package name a1) of a package formed from software to be used for applications of speech processing, the package name a2 of a package formed from software to be used for applications of image processing and the package name a3 of a package formed from software to be used for applications of communication processing.

Referring back to FIG. 6, if the user then uses, at step S6, the operation section 18 of the personal computer 1 to operate a checkbox of the package designation screen to designate a package name, then the CPU 11 acquires a URL corresponding to the designated package. Then at step S7, the CPU 11 issues a request for data of a software designation screen based on data of a homepage designated by the URL to the Web server 2.

The CPU 41 of the Web server 2 reads out, at step S24, a package ID stored in the designated homepage in accordance with the request from the personal computer 1 and controls the communication section 49 to transmit the package ID to the database server 3.

The CPU 71 of the database server 3 refers, at step S42, to a predetermined table (table 2) recorded on the hard disk 74 to detect a software title ID, a version name, a software title name and a category name of the software corresponding to the package ID transmitted from the Web server 2.

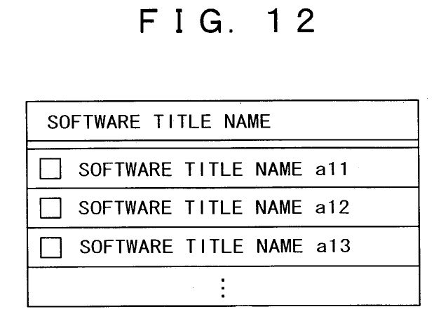

FIG. 11 shows an example of a data configuration of the table 2. Referring to FIG. 11, in the Web server 2, a package VS software part ID and a software ID (identification number of software) of a plurality of pieces of software corresponding to each package IDa are matched with the package IDa.

With each software ID, a software title ID (identification number of a software name), a category ID and a version name are matched. Further, with the software title ID, a software title name (name of the piece of software) is matched, and with the category ID, a category name is matched.

The category ID is provided so as to make it possible to discriminate whether the piece of software is for an application or for the BIOS, and is a number corresponding to its division. The category name is the name of the division.

Referring back to FIG. 6, the CPU 71 of the database server 3 first detects software IDa11, IDa12, . . . matched with the package ID (for example, package IDa1) transmitted from the Web server 2. Then, the CPU 71 acquires the software title IDa11, category IDa11 and version name all, the software title IDa12, category IDa12 and version name a12, and so forth matched with the detected software IDa11, IDa12, . . . , respectively.

The CPU 71 further acquires the category names a11, a12, . . . matched with the categories IDa11, IDa12, . . . , respectively. It is to be noted that, if the software can be automatically installed into the personal computer 1, it is prescribed that the category name includes characters of, for example, “auto”. In other words, if an installer for the software is stored in the file server 4, then the category name of the software includes the characters of “auto”.

The CPU 71 of the database server 3 controls the communication section 79 to transmit the thus acquired software title IDs, version names, software title names and category names to the Web server 2.

Referring back to FIG. 6, at step S25, the CPU 41 of the Web server 2 detects those of the version names transmitted from the database server 3 at step S42 which include the characters of “auto”. In other words, the CPU 41 detects those pieces of software which can be installed automatically.

Then at step S26, the CPU 41 of the Web server 2 detects those of the software title IDs, version names, software title names and category names transmitted from the database server 3 which relate to the version name detected at step S25, and produces a screen (software designation screen) for designating the software based on the detected items. The CPU 41 controls the communication section 49 to transmit the thus produced software designation screen to the personal computer 1.

The CPU 11 of the personal computer 1 controls, at step S8, the display section 17 to display the software designation screen transmitted from the Web server 2.

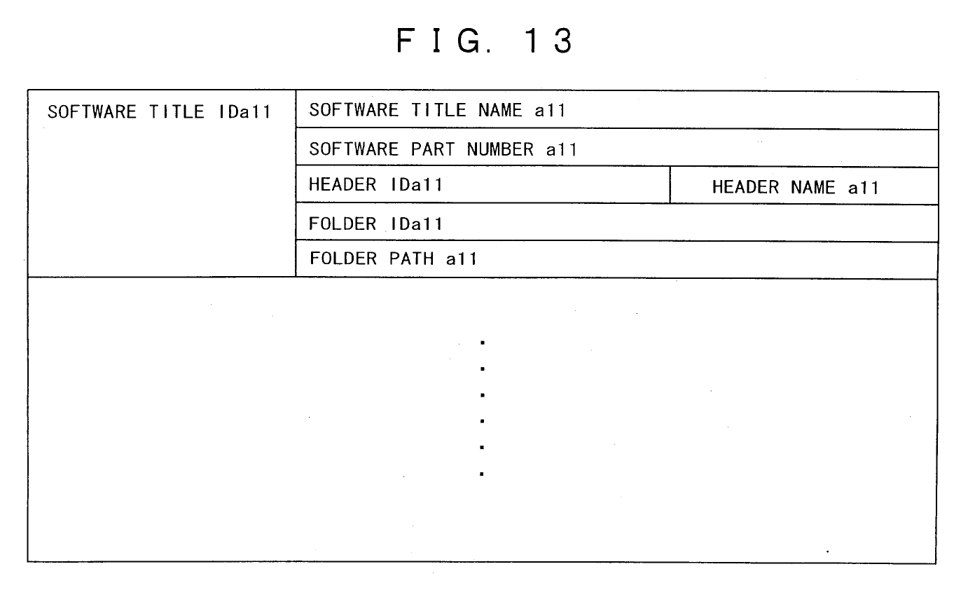

FIG. 12 shows an example of a display of the software designation screen. Referring to FIG. 12, the names (software title names) of those pieces of software which belong to the package designated at step S6 and can be installed automatically are displayed on the software designation screen. It is to be noted that a URL is matched with each software title name, and the Web server 2 stores the following data in a homepage corresponding to the URL:

*image name ID,

*package ID,

*package name,

*software title name,

*software title ID,

*version name, and

*category name.

In the example of FIG. 12, software title names a11, a12, a13, . . . of those pieces of software which belong to the package corresponding to the package name a1 shown in FIG. 10 and can be installed automatically are displayed.

Then, if the user uses, at step S9 (FIG. 7), the operation section 18 of the personal computer 1 to operate a checkbox of the software designation screen to designate a software title name, then the CPU 11 acquires a URL corresponding to the designated software title name. Then at step S10, the operation section 18 issues a request for data of an install software list screen based on data of the homepage designated by the URL to the Web server 2.

The CPU 41 of the Web server 2 detects, at step S27, an image name ID, a software title ID and a version name stored in the designated homepage in response to the request from the personal computer 1 and controls the communication section 49 to transmit the image name ID and the software title name among them to the database server 3.

The CPU 71 of the database server 3 refers, at step S43, to predetermined tables (tables 3A and 3B) stored in the hard disk 74 to detect an installation style name, a software title name, a folder path and a software part number matched with both of the image name ID and the software title ID received from the Web server 2.

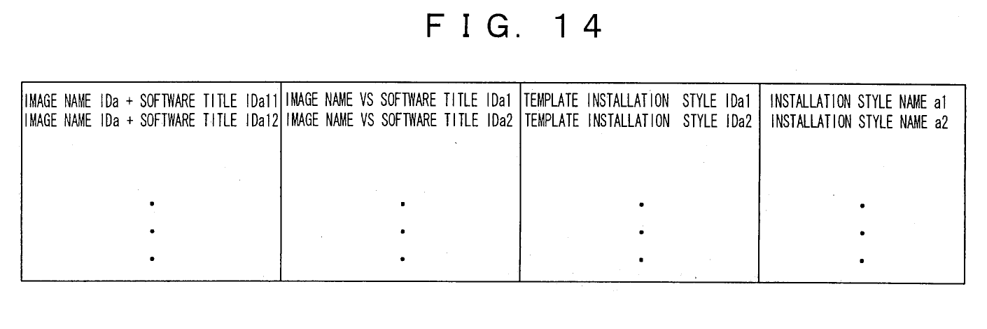

FIG. 13 shows a data configuration of the table 3A. Referring to FIG. 13, in the table 3A shown, a software title name, a software part number, a header ID with which a header name is matched, a folder ID and a folder path are matched with each software title ID.

It is to be noted that the folder ID is identification information of a folder in the file server 4 in which various files which form an installer for the software are stored, and the folder path is information representative of a place in the file server 4 in which the folder exists. It is to be noted that a folder in which an installer is stored has the software part number of the software applied thereto.

The header name is a character string applied to a top portion of the software part number and is used for identification of the software part number. The header ID is an identification number of the header name.

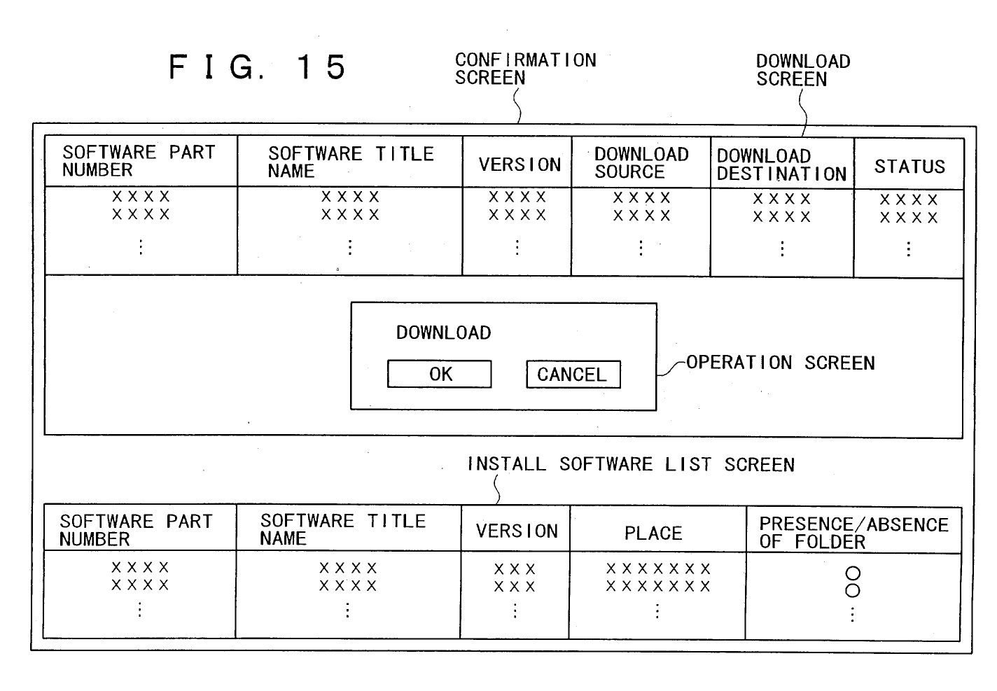

FIG. 14 shows a data configuration of the table 3B. Referring to FIG. 14, in the table 3B shown, an image name VS software title ID (a number based on an image name ID and a software title ID) is matched with an image name Id and a software title ID (image name ID+software title ID), and a template installation style ID is matched with the image name VS software title ID, and besides an installation style name is matched with the template installation style ID.

The installation style name includes a predetermined character string (for example, auto) where the software can be automatically installed into the machine type corresponding to the image name ID. Even if the software itself originally is of the type which can be automatically installed, the installer thereof does not sometimes operate appropriately depending upon the affinity with the machine type into which the software is to be installed. Therefore, the table 3B indicates matching between different machine types and software so that it can be discriminated whether or not the software can be automatically installed into a particular machine type. The template installation style ID is a number corresponding to the installation style name.

Thus, referring back to FIG. 7, the CPU 71 of the database server 3 first refers to the table 3A to detect a software title name, a software part number, a header ID and a folder path matched with the software title ID received from the Web server 2. Then, the CPU 71 detects a header name matched with the detected header ID.

The CPU 71 further refers to the table 3B to detect an image name VS software title ID matched with both of the image name ID and the software title ID received from the Web server 2 and detect a template installation style ID matched with the image name VS software title ID and further detect an installation style name matched with the template installation style ID.

The CPU 71 controls the communication section 79 to transmit the installation style name, software title name, folder path and software part number detected in such a manner as described above to the Web server 2.

At step S28 of FIG. 7, the CPU 41 of the Web server 2 detects those of the installation style names transmitted from the database server 3 at step S43 which include the character string of “auto”.

At step S29, the CPU 41 of the Web server 2 detects those of the software part numbers received from the database server 3 which correspond to the installation style names (which include “auto”) detected at step S28, and detects those of the detected software part numbers which are applied to the folder stored in the file server 4.

Then at step S30, the CPU 41 of the Web server 2 produces a list (install software list screen) of those pieces of software to be installed based on the software part numbers detected at step S29, the software title names and the folder paths received from the database server 3 and corresponding to the software part numbers, and the version name detected at step S27, and controls the communication section 49 to transmit the install software list screen to the personal computer 1.

The CPU 11 of the personal computer 1 causes, at step S11, the install software list screen transmitted from the Web server 2 to be displayed.

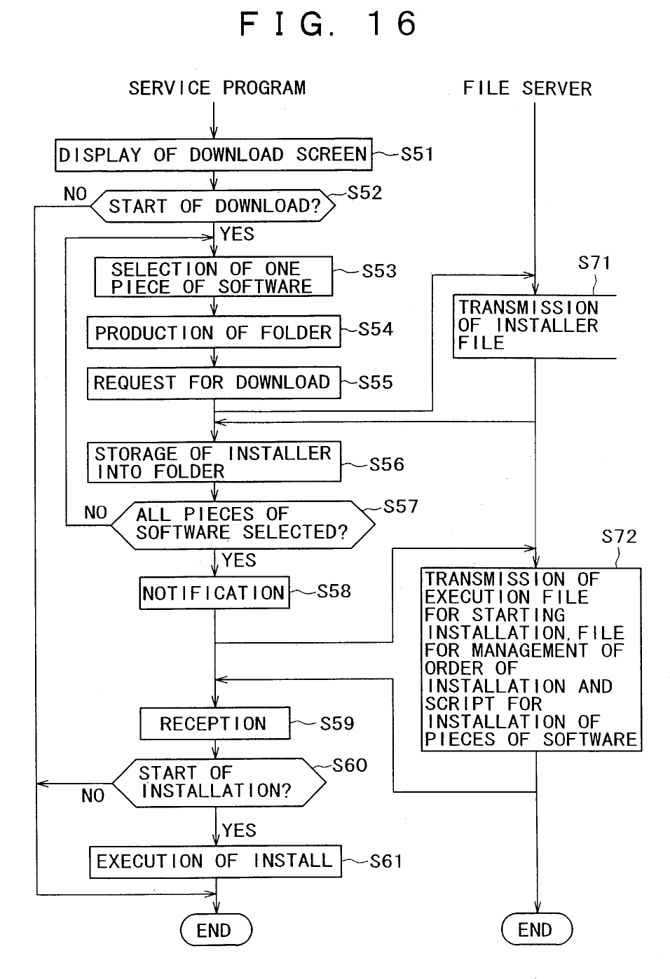

FIG. 15 shows an example of a display of the install software list screen. It is to be noted that, although the install software list screen forms a confirmation screen together with a download screen (a screen displayed on the upper side) and an operation screen which are displayed by a process hereinafter described), at this point of time, a download screen and an operation screen are not display as yet.

The install software list screen indicates a software part number, a software title name, a version (version name), a place (folder path) and presence or absence of a folder. Consequently, the user can recognize those pieces of software which can be installed from the display.

Thereafter, the processing of the CPU 11 (WWW browser) of the personal computer 1 is ended.

Meanwhile, the CPU 41 of the Web server 2 sets, at step S31, the software part numbers detected at step S29, the software title names and the folder paths transmitted from the database server 3 at step S43 and corresponding to the software part numbers and the version name detected at step S27 to a program (hereinafter referred to as service program) necessary for the personal computer 1 to communicate with the file server 4. It is to be noted that the software part numbers include incidental information representative of the order of installation.

Then at step S32, the CPU 41 of the Web server 2 controls the communication section 49 to transmit the service program, whose predetermined information has been registered at step S31, to the personal computer 1. Thereafter the CPU 41 ends the processing.

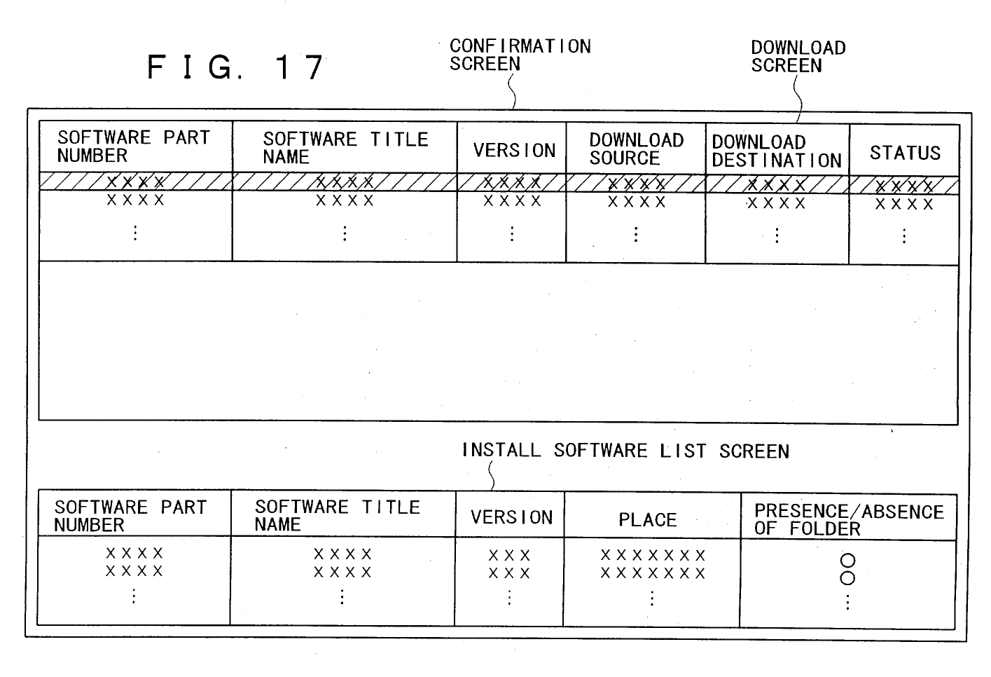

Subsequently, a processing procedure when one of the pieces of software indicated in the install software list screen is installed is described with reference to a flow chart of FIG. 16.

When the service program transmitted from the Web server 2 is received by the personal computer 1 at step S32 of FIG. 7, the CPU 11 starts up the service program. Then, the CPU 11 (service program) of the personal computer 1 controls the display section 17 to display such a download screen as shown in FIG. 15 at step S51.

Referring to FIG. 15, the download screen indicates a software part number, a software title name, a version (version name), a download source (folder path of the file server 4), a download destination (a place in the personal computer 1 in which a folder to be produced is to exist as hereinafter described) and a status of whether or not downloading has been performed. Further, at a central portion of the screen, an operation screen is displayed which includes an OK button operated in order to start downloading of an installer and a cancel button operated in order to stop downloading.

Referring back to FIG. 16, at step S52, the CPU 11 of the personal computer 1 discriminates whether or not a request to download the installer is issued. If it is discriminated that such a request is issued, that is, when the OK button of the operation screen is operated, the processing advances to step S53.

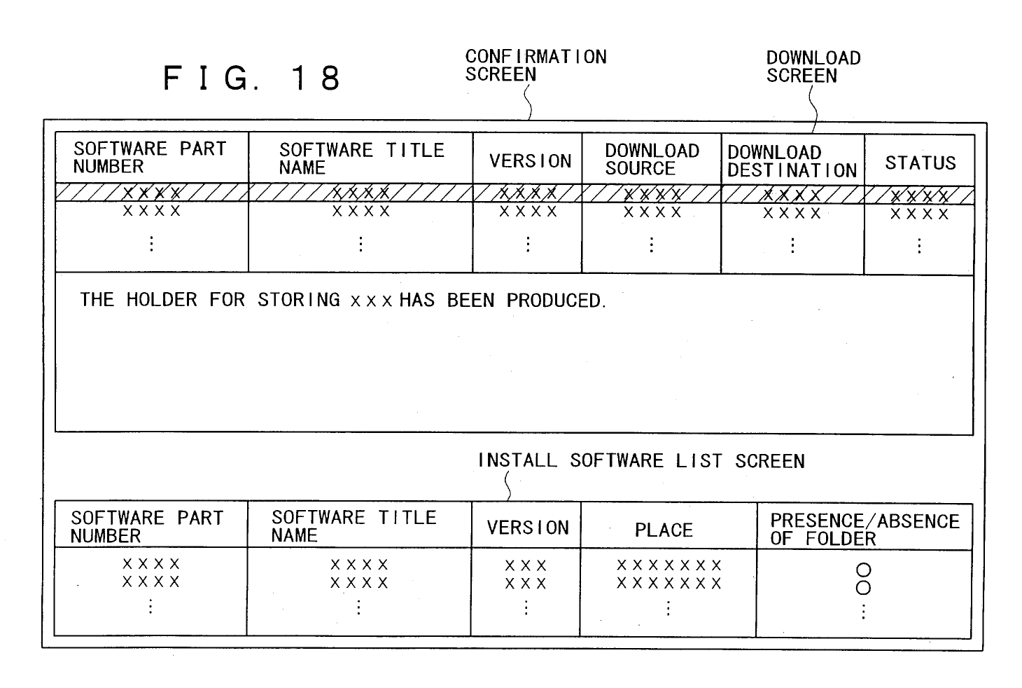

At step S53, the CPU 11 of the personal computer 1 selects one of the pieces of software to be installed. At this time, the CPU 11 controls the display section 17 to apply a shade to the display (row) (first, the uppermost row) on the download screen corresponding to the selected piece of software as shown in FIG. 17.

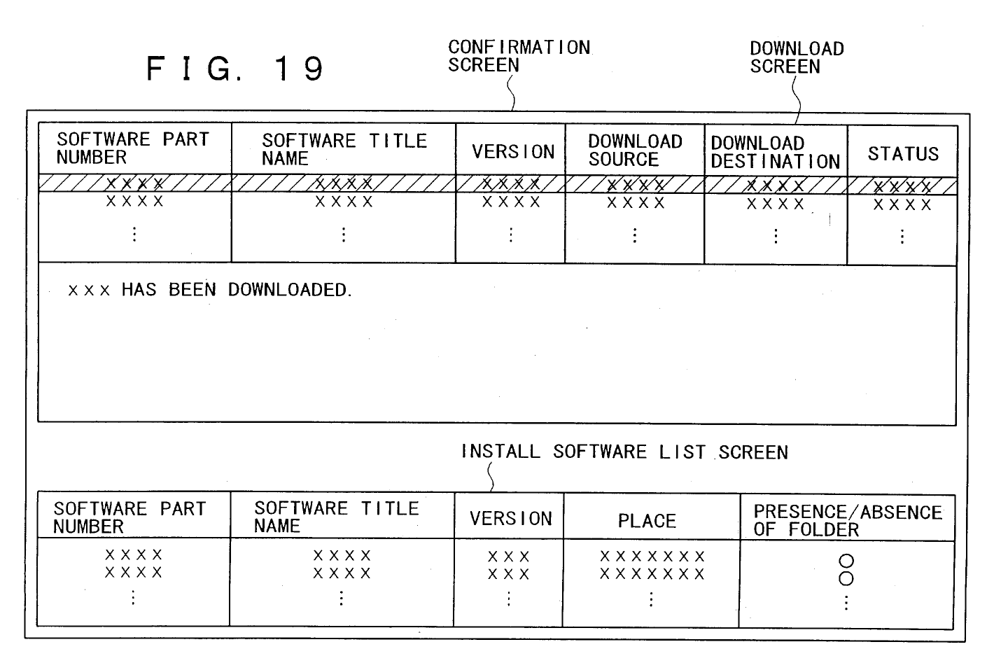

Then at step S54, the CPU 11 of the personal computer 1 produces a folder into which the installer for the piece of software selected at step S53 should be stored (more precisely, a folder into which a file of the software body which form the installer, a file for setting information and so forth should be stored) with the software part number applied thereto. At this time, the CPU 11 displays a message representing this at a central portion of the confirmation screen as shown in FIG. 18. It is to be noted that, at this time, the operation screen is erased.

At step S55, the CPU 11 of the personal computer 1 controls the communication section 19 to transmit the software part number of the piece of software selected at step S53 to the file server 4 and issues a request for downloading of the installer for the piece of software.

The CPU 101 of the file server 4 controls, at step S71, the communication section 109 to transmit.the installer to the personal computer 1 in accordance with the request from the personal computer 1 (more precisely, transmits the file of the program body of the software, a file of setting information and so forth which form the installer).

The CPU 11 of the personal computer 1 stores, at step S56, the installer transmitted (downloaded) from the file server 4 into the folder produced at step S54. Thereupon, the CPU 11 causes a message representing this to be displayed at a central portion of the confirmation screen as shown in FIG. 19.

Then at step S57, the CPU 11 of the personal computer 1 discriminates whether or not there still exists a piece of software which has not been selected at step S53, that is, whether or not the installer for all of the pieces of software to be installed has been downloaded. If it is discriminated that some installer which has not been downloaded as yet still exists, then the processing returns to step S53, at which the CPU 11 performs a similar process for the next piece of software.

If it is discriminated at step S57 that the installer for all of the pieces of software has been downloaded, then the processing advances to step S58, at which the CPU 11 of the personal computer 1 controls the communication section 19 to notify the file server 4 of such completion of the downloading.

When the CPU 101 of the file server 4 receives the notification from the personal computer 1, it controls, at step S72, the communication section 109 to transmit an execution file for starting the installation, a management file representative of the order of the installation and a script for causing the installer for the software to be executed to the personal computer 1.

When the CPU 11 of the personal computer 1 receives, at step S59, the execution file, management file and script transmitted from the file server 4, it discriminates, at step S60, whether or not the operation section 18 is operated by the user to issue an instruction to start installation. If it is discriminated that such an instruction is issued, then the processing advances to step S61, at which the CPU 11 executes installation of the software. It is to be noted that, where the software is installed already, the CPU 11 may refrain from execution of the process at step S61.

More particularly, the CPU 11 suitably reads out the script so that the installation may be performed in the order as indicated by the management file. The script thus read out executes the installer stored in the folder. As a result, installation of the pieces of software is performed in the order as indicated by the management file.

Thereafter, the processing is ended. The software is installed in such a manner as described above.

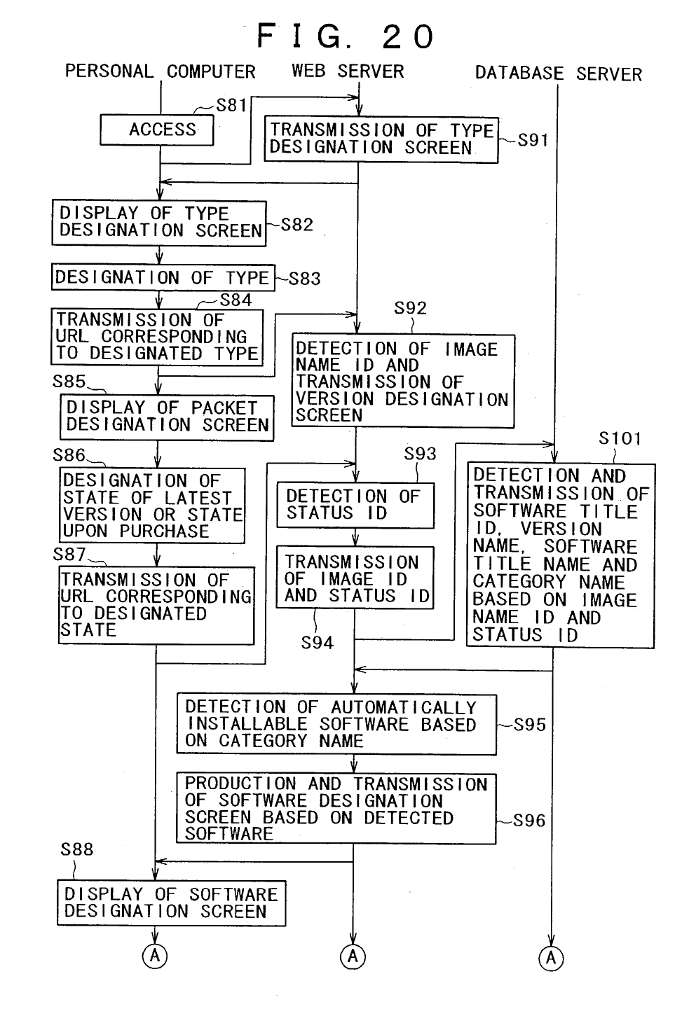

It is to be noted that, while, in the foregoing description, different pieces of software are selected and installed for different applications, it is otherwise possible to arbitrarily select and install a version. A processing procedure in this instance is described with reference to a flow chart of FIG. 20.

If the Web browser is started up on the personal computer 1 and a predetermined URL is inputted by the user, then the CPU 11 (Web browser) controls, at step S81, the communication section 19 to transfer a command of the HTTP for requesting data of a type designation screen for designating a machine type to the Web server 2 through the Internet 5.

When the command from the personal computer 1 is received, the CPU 41 of the Web server 2 reads out, at step S91, data of the type selection screen of a homepage designated by the command from the hard disk 44 and controls the communication section 49 to transmit the data to the personal computer 1.

The CPU 11 of the personal computer 1 controls, at step S82, the display section 17 to display the type selection screen transmitted from the Web server 2 as shown in FIG. 8.

The Web server 2 stores IDs (image name IDs) of various machine types in the homepage corresponding to the URL matched with the type name of FIG. 8.

If the user of the personal computer 1 uses the operation section 18 to operate one of checkboxes provided corresponding to the type names of the type selection screen to designate a machine type name, then the CPU 11 acquires a URL corresponding to the designated type name at step S83, and issues a request for a version designation screen based on data of a homepage designated by the URL to the Web server 2 at step S84.

The CPU 41 of the Web server 2 detects, at step S92, an image name ID stored in the designated homepage in accordance with the request from the personal computer 1. The CPU 41 further controls the communication section 49 to transmit data of the version designation screen stored in the designated homepage to the database server 3.

The CPU 11 of the personal computer 1 controls, at step S85, the display section 17 to display the version designation screen transmitted from the Web server 2.

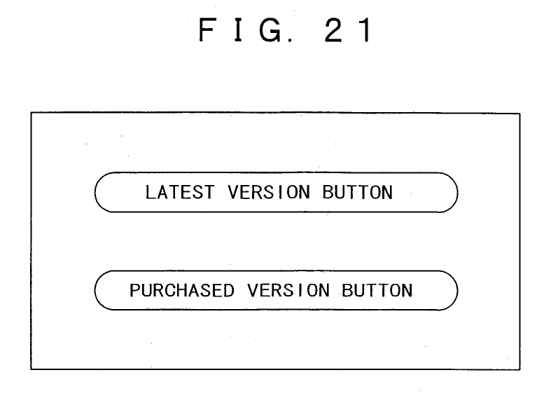

FIG. 21 shows an example of the version designation screen. Referring to FIG. 21, on the screen shown, a latest version button operated in order to install the software of the latest version and a purchased version button operated in order to install the software of the version installed when the personal computer 1 was purchased are displayed. It is to be noted that a URL is matched with each of the buttons,. and the Web server 2 stores a status ID in a homepage corresponding to the URL.

If the user uses the operation section 18 of the personal computer 1 to operate the latest version button or the purchased version button of the version designation screen, then the CPU 11 acquires a URL corresponding to the operated button at step S86, and issues a request for data of a software designation screen based on data of the homepage designated by the URL to the Web server 2 at step S87.

The CPU 41 of the Web server 2 detects, at step S93, a status ID stored in the designated homepage in accordance with the request from the personal computer 1, and controls, at step S94, the communication section 49 to transmit the thus detected status ID and the image name ID detected at step S92 to the database server 3.

The CPU 71 of the database server 3 refers, at step S101, to a predetermined table (table 4) recorded on the hard disk 74 to detect a software title ID, a version name, a software title name and a category name corresponding to the image name ID and the status ID transmitted from the Web server 2.

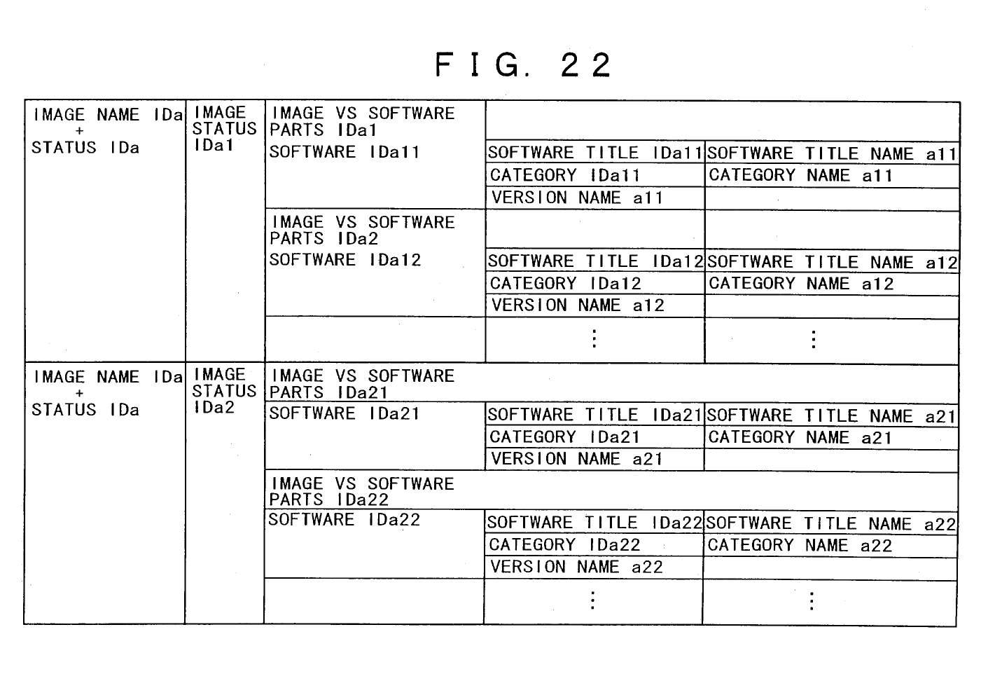

FIG. 22 shows an example of a data configuration of the table 4. Referring to FIG. 22, in the table 4, an image status ID (a number based on an image name ID and a status ID) is matched with an image name ID and a status ID (image name ID+status ID), and image VS software part IDs and software IDs of a plurality of pieces of software corresponding to the image status ID are matched with the image status ID.

Further, with each of the software IDs, a software title ID, a category ID and a version name are matched in a similar manner as in the table 1. Furthermore, with the software title ID, a software title name is matched, and with the category ID, a category name is matched.

Thus, the CPU 71 of the database server 3 first detects an image status IDa1 matched with the image name ID and the status ID (for example, image name IDa and status IDa) transmitted from the Web server 2, and detects pieces IDa11, IDa12, . . . of software matched with the image status IDa1. Then, the CPU 71 acquires a software title IDa11, a category IDa11 and a version name a11 associated with the detected software piece IDa11, a software title IDa12, a category IDa12 and a version name a12 associated with the detected software piece IDa12, and so forth.

The CPU 71 further acquires category names a11, a12, . . . matched with the categories IDa11, IDa12, . . . , respectively.

The CPU 71 of the database server 3 controls the communication section 79 to transmit the acquired software title IDs, version names, software title names and category names to the Web server 2.

Referring back to FIG. 20, at step S95, the CPU 41 of the Web server 2 detects those of the version names transmitted from the database server 3 at step S101 which include the character string of “auto”. In other words, those pieces of software which can be installed automatically are detected.

Then at step S96, the CPU 41 of the Web server 2 detects those of the software title IDs, version names and software title names transmitted from the database server 3 which relate to the version name detected at step S95 and produces a software designation screen for designating software based on the detected items. Then, the CPU 41 controls the communication section 49 to transmit the software designation screen to the personal computer 1.

Then at step S88, the CPU 11 of the personal computer 1 controls the display section 17 to display the software designation screen transmitted from the Web server 2 in such a manner as shown in FIG. 12.

Thereafter, the personal computer 1 performs processes similar to those at steps S9 to S11 of FIG. 7 while the Web server 2 performs processes similar to those at steps S27 to S32 of FIG. 7 and the database server 3 performs processes similar to those at step S43 of FIG. 7. Thus, overlapping description of such processes is omitted herein to avoid redundancy.

While the series of processes described above can be executed by hardware, it may otherwise be executed by software. Where the series of processes is executed by software, a program which constructs the software is installed from a program storage medium into a computer incorporated in hardware for exclusive use or, for example, a personal computer for universal use which can execute various functions by installing various programs.

It is to be noted that, in the present specification, the steps which describe the program provided in the form of a medium may be but need not necessarily be processed in a time series in the order as described, and include processes which are executed in parallel or individually without being processed in a time series.

Further, in the present specification, the term system is used to represent an entire apparatus formed from a plurality of apparatus.

While a preferred embodiment of the present invention has been described using specific terms, such description is for illustrative purposes only, and it is to be understood that changes and variations may be made without departing from the spirit or scope of the following claims.

In the Drawings:

FIG. 1

1 . . . Personal computer

2 . . . Web server

3 . . . Database server

4 . . . File server

FIG. 2

14 . . . Hard disk

16 . . . Input/output interface

17 . . . Display section

18 . . . Operation section

19 . . . Communication section

20 . . . Drive

FIG. 3

44 . . . Hard disk

46 . . . Input/output interface

47 . . . Display section

48 . . . Operation section

49 . . . Communication section

50 . . . Drive

FIG. 4

74 . . . Hard disk

76 . . . Input/output interface

77 . . . Display section

78 . . . Operation section

79 . . . Communication section

80 . . . Drive

FIG. 5

104 . . . Hard disk

106 . . . Input/output interface

107 . . . Display section

108 . . . Operation section

109 . . . Communication section

110 . . . Drive

FIG. 6

Top, left . . . Personal computer

Top, middle . . . Web server

Top, right . . . Database server

S1 . . . Access

S2 . . . Display of type designation screen

S3 . . . Designation of type

S4 . . . Transmission of URL corresponding to designated type

S5 . . . Display of packet designation screen

S6 . . . Designation of package

S7 . . . Transmission of URL corresponding to designated package

S8 . . . Display of software designation screen

S21 . . . Transmission of type designation screen

S22 . . . Readout and transmission of image name ID

S23 . . . Production and transmission of package designation screen

S24 . . . Readout and transmission of package ID

S25 . . . Detection of automatically installable software based on category name

S26 . . . Production and transmission of software designation screen based on detected software

S41 . . . Detection and transmission of package ID and package name based on image name ID

S42 . . . Detection and transmission of software title ID, version name, software title name and category name based on package ID

FIG. 7

Top, left . . . Personal computer

Top, middle . . . Web server

Top, right . . . Database server

S9 . . . Designation of software

S10 . . . Transmission of URL corresponding to designated software

S11 . . . Display of install software list screen

Below S11 . . . End

S27 . . . Detection and transmission of image name ID and software title ID

S28 . . . Detection of automatically installable software based on installation style name

S29 . . . Detection of software whose installer exists in file server

S30 . . . Production and transmission of install software list screen

S31 . . . Registration of software title name, version name, folder path, software part numbers (in installation order) into service program

S32 . . . Transmission of service program

Below S32 . . . End

S43 . . . Detection and transmission of installation style name, software title name, folder path and software part numbers based on image name ID and software title ID

Below S43 . . . End

FIG. 8, from above

Type Name

Type name A

Type name B

Type name C

FIG. 9, from above, from left

Image name IDa

Package IDa1

Package name a1

Package IDa2

Package name a2

Package IDa3

Package name a3

Image name IDb

Package IDb1

Package name b1

Package IDb2

Package name b2

FIG. 10, from above, from left

Application

Package name

Music

Package name a1

Image

Package name a2

Communication

Package name a3

FIG. 11, from left, from above

Package IDa1

Package IDa2

Package VS software parts IDa1

Software IDa11

Package VS software parts IDa2

Software IDa12

Package VS software parts IDa21

Software IDa21

Package VS software parts IDa22

Software IDa22

Software title IDa11

Category IDa11

Version name a11

Software title IDa12

Category IDa12

Version name a12

Software title IDa21

Category IDa21

Version name a21

Software title IDa22

Category IDa22

Version name a22

Software title name a11

Category name a11

Software title name a12

Category name a12

Software title name a21

Category name a21

Software title name a22

Category name a22

FIG. 12, from above

Software title name

Software title name a11

Software title name a12

Software title name a13

FIG. 13, from above, from left

Software title IDa11

Software title name a11

Software part number a11

Header IDa11

Header name a11

Folder IDa11

Folder path a11

FIG. 14, from left, from above

Image name IDa+software title IDa11

Image name IDa+software title IDa12

Image name VS software title IDa1

Image name VS software title IDa2

Template installation style IDa1

Template installation style IDa2

Installation style name a1

Installation style name a2

FIG. 15, from above, from left

Confirmation screen

Download screen

Software part number

Software title name

Version

Download source

Download destination

Status

Download

Operation screen

Cancel

Install software list screen

Software part number

Software title name

Version

Place

Presence/absence of folder

FIG. 16

Top, left . . . Service program

Top, right . . . File server

S51 . . . Display of download screen

S52 . . . Start of download?

S53 . . . Selection of one piece of software

S54 . . . Production of folder

S55 . . . Request for download

S56 . . . Storage of installer into folder

S57 . . . All pieces of software selected?

S58 . . . Notification

S59 . . . Reception

S60 . . . Start of installation?

S61 . . . Execution of install

Below S61 . . . End

S71 . . . Transmission of installer file

S72 . . . Transmission of execution file for starting installation, file for management of order of installation and script for installation of pieces of software

Below S72 . . . End

FIG. 17, from above, from left

Confirmation screen

Download screen

Software part number

Software title name

Version

Download source

Download destination

Status

Install software list screen

Software part number

Software title name

Version

Place

Presence/absence of folder

FIG. 18

Confirmation screen

Download screen

Software part number

Software title name

Version

Download source

Download destination

Status

The folder for storing xxx has been produced.

Install software list screen

Software part number

Software title name

Version

Place

Presence/absence of folder

FIG. 19, from above, from left

Confirmation screen

Download screen

Software part number

Software title name

Version

Download source

Download destination

Status

xxx has been downloaded.

Install software list screen

Software part number

Software title name

Version

Place

Presence/absence of folder

FIG. 20

Top, left . . . Personal computer,

Top, middle . . . Web server

Top, right . . . Database server

S81 . . . Access

S82 . . . Display of type designation screen

S83 . . . Designation of type

S84 . . . Transmission of URL corresponding to designated type

S85 . . . Display of packet designation screen

S86 . . . Designation of state of latest version or state upon purchase

S87 . . . Transmission of URL corresponding to designated state

S88 . . . Display of software designation screen

S91 . . . Transmission of type designation screen

S92 . . . Detection of image name ID and transmission of version designation screen

S93 . . . Detection of status ID

S94 . . . Transmission of image ID and status ID

S95 . . . Detection of automatically installable software based on category name

S96 . . . Production and transmission of software designation screen based on detected software

S101 . . . Detection and transmission of software title ID, version name, software title name and category name based on image name ID and status ID

FIG. 21, from above

Latest version button

Purchased version button

FIG. 22, from left, from above

Image name IDa+status IDa

Image name IDa+status IDa

Image status IDa1

Image status IDa

Image VS software part IDa1

Software IDa11

Image VS software part IDa2

Software IDa12

Image VS software part IDa21

Software IDa21

Image VS software part IDa22

Software IDa22

Software title IDa11

Category IDa11

Version name a11

Software title IDa12

Category IDa12

Version name a12

Software title IDa21

Category IDa21

Version name a21

Software title IDa22

Category IDa22

Version name a22

Software title name a11

Category name a11

Software title name a12

Category name a12

Software title name a21

Category name a21

Software title name a22

Category name a22

What is claimed is:

1. An information processing system, comprising:
a management server;
a software information server;
a terminal;
an install information server; and
a network for interconnecting said management server, software information server, terminal and install information server;
said management server including first transmission means for acquiring apparatus information of said terminal and transmitting the apparatus information to said software information server, second transmission means for producing, based on first software information, transmitted from said software information server, of software corresponding to the apparatus information transmitted by said first transmission means, first designation information for designating the software and transmitting the first designation information to said terminal, third transmission means for transmitting the first software information of the software designated based on the first designation information by said terminal to said software information server, and fourth transmission means for transmitting second software information, transmitted from said software information server, of the software corresponding to the first software information transmitted by said third transmission means;
said software information server including first storage means for storing the first software information in a matched relationship with the apparatus information and storing the second software information in a matched relationship with part or the entirety of the first software information, first search means for searching said first storage means for the first software information matched with the apparatus information transmitted by said first transmission means of said management server, fifth transmission means for transmitting the first software information searched out by said first search means to said management server, second search means for searching said first storage means for the second software information matched with the first software information transmitted by said third transmission means of said management server, and sixth transmission means for transmitting the second software information searched out by said second search means to said management server;
said terminal including first designation means for designating the software based on the first designation information transmitted from said second transmission means of said management server, requesting means for requesting install information corresponding to the second software information transmitted by said fourth transmission means of said management server to said install information server, and install means for installing the software based on the install information transmitted from said install information server in response to the request from said requesting means;
said install information server including second storage means for storing the install information in a matched relationship with part or the entirety of the second software information, third search means for searching said second search means for the install information of the object of the request from said requesting means of said terminal, and seventh transmission means for transmitting the install information searched out by said third search means to said terminal.

2. An information processing system according to claim 1, wherein said network is the Internet and said management server is a Web server while said software information server is a server which can be accessed by said Web server using the SQL and said install information server is a server which can be connected by said terminal using the FTP.

3. An information processing system according to claim 1, wherein said management server further includes eighth transmission means for producing, based on division information, transmitted from said software information server, of the software corresponding to the apparatus information transmitted by said first transmission means, second destination information for designating a division and transmitting the second designation information to said terminal, and ninth transmission means for transmitting the division information of the division designated based on the second designation information by said terminal to said software information server, said second transmission means producing and transmitting to said terminal the first designation information based on the first software information, transmitted from said software information server, of the software belonging to the division corresponding to the division information transmitted by said ninth transmission means, said first storage means of said software information server storing the division information in a matched relationship with the apparatus information while storing the first software information of the software belonging to the division corresponding to the division information in a matched relationship with the division information and storing the second software information in a matched relationship with part or the entirety of the first software information, said first search means being operable to search said first storage means for the division information matched with the apparatus information transmitted by said first transmission means of said server and search said first storage means for the first software information matched with the division information transmitted by said ninth transmission means of said management server, said terminal further including second designation means for designating the division based on the second designation information transmitted by said eighth transmission means of said management server.

4. An information processing system according to claim 1, wherein said first transmission means of said management server acquires the apparatus information of said terminal and state information representative of a state of the software to be installed from said terminal and transmits the apparatus information and the state information to said software information server, and said second transmission means produces the first designation information for designating the software based on the first software information, transmitted from said software information server, of the software corresponding to the apparatus information and the state information transmitted from said first transmission means, said first storage means of said software information server storing the first software information in a matched relationship with the apparatus information and the state information while storing the second software information in a matched relationship with part or the entirety of the first software information, said first search means searching said first storage means for the first software information matched with the apparatus information and the state information transmitted from said first transmission means of said management server.

5. An information processing system according to claim 1, wherein the install information is an installer, and the first software information includes identification information of the software while the second software information includes information representative of a place in said install information server at which the installer is stored.

6. An information processing system according to claim 5, wherein the first software information includes information representative of whether or not the installer is stored in said install information server, and said second transmission means of said management server produces a first designation screen based on the second software information which includes information representing that the installer is stored in said install information server and transmits the first designation screen to said terminal.

7. An information processing system according to claim 6, wherein the second software information includes information representative of whether or not the installer stored in said install information server operates appropriately on said terminal, and said fourth transmission means of said management server transmits the second software information which includes information representing that the installer operates appropriately on said terminal to said terminal.

8. An information processing system according to claim 1, wherein said install means of said terminal does not install the software to be installed based on the install information transmitted from said install information server where the software is installed already.

9. An information processing apparatus, comprising:
a terminal into which software is to be installed;
a server for managing information regarding the software;
first transmission means for acquiring apparatus information of said terminal from said terminal and transmitting the apparatus information to said server;
second transmission means for producing, based on first software information, transmitted from said server, of the software corresponding to the apparatus information transmitted by said first transmission means, designation information for designating the software, the first software information including identification information of the software, and transmitting the designation information to said terminal;
third transmission means for transmitting the first software information of the software designated based on the designation information by said terminal to said server; and
fourth transmission means for transmitting second software information transmitted from said server and corresponding to the first software information transmitted by said third transmission means to said terminal, the second software information including information representative of a place at which information for installing the software exists.

10. An information processing method, comprising:
a first transmission step of acquiring, from a terminal into which software is to be installed, apparatus information of said terminal and transmitting the apparatus information to a server which manages information regarding the software;
a second transmission step of producing, based on first software information, transmitted from said server, of the software corresponding to the apparatus information transmitted by the process at the first transmission step, designation information for designating the software, the first software information including identification information of the software, and transmitting the designation information to said terminal;
a third transmission step of transmitting the first software information of the software designated based on the designation information by said terminal to said server; and
a fourth transmission step of transmitting second software information transmitted from said server and corresponding to the first software information transmitted by the process at the third transmission step to said terminal, the second software information including information representative of a place at which information for installing the software exists.

11. A program for causing a computer to execute a process including:
a first transmission controlling step of controlling acquisition, from a terminal into which software is to be installed, of apparatus information of said terminal and transmission of the apparatus information to a server which manages information regarding the software;
a second transmission controlling step of controlling production, based on first software information, transmitted from said server, of the software corresponding to the apparatus information transmitted by the process at the first transmission controlling step, of designation information for designating the software, the first software information including identification information of the software, and transmission of the designation information to said terminal;
a third transmission controlling step of controlling transmission of the first software information of the software designated based on the designation information by said terminal to said server; and
a fourth transmission controlling step of controlling transmission of second software information transmitted from said server and corresponding to the first software information transmitted by the process at the third transmission controlling step to said terminal, the second software information including information representative of a place at which information for installing the software exists.

12. An information processing apparatus connectable to a terminal and a server through a network, comprising:
first storage means for storing first software information of software which can be installed by said terminal in a matched relationship with apparatus information of said terminal, the first software information including identification information of the software, and storing second software information of the software including information representative of a place at which information necessary for installing the software exists in a matched relationship with part or the entirety of the first software information;
first search means for searching said first storage means for the first software information matched with the apparatus information transmitted from said server;
first transmission means for transmitting the first software information searched out by said first search means to said server;
second search means for searching said first storage means for the second software information matched with the first software information transmitted from said server; and
second transmission means for transmitting the software information searched out by said second search means to said server so that said server may transmit the second software information to said server.

13. An information processing method for an information processing apparatus connectable to a terminal and a server through a network, comprising:
a storage step of storing first software information of software which can be installed by said terminal in a matched relationship with apparatus information of said terminal, the first software information including identification information of the software, and storing second software information of the software including information representative of a place at which information necessary for installing the software exists in a matched relationship with part or the entirety of the first software information;
a first search step of searching for the first software information matched with the apparatus information transmitted from said server from the storage step;
a first transmission step of transmitting the first software information searched out by the process at the first search step to said server;
a second search step of searching for the second software information matched with the first software information transmitted from said server from the storage step; and
a second transmission step of transmitting the software information searched out by the process at the second search step to said server so that said server may transmit the second software information to said server.

14. A program for an information processing apparatus connectable to a terminal and a server through a network, the program causing a computer to execute a process including:
a storage controlling step of controlling storage of first software information of software which can be installed by said terminal in a matched relationship with apparatus information of said terminal, the first software information including identification information of the software, and storage of second software information of the software including information representative of a place at which information necessary for installing the software exists in a matched relationship with part or the entirety of the first software information;
a first search controlling step of controlling search for the first software information matched with the apparatus information transmitted from said server;
a first transmission controlling step of controlling transmission of the first software information searched out by the process at the first search controlling step to said server;
a second search controlling step of controlling search for the second software information matched with the first software information transmitted from said server; and
a second transmission controlling step of controlling transmission of the second software information searched out by the process at the second search controlling step to said server so that said server may transmit the second software information to said server.

15. An information processing apparatus connectable to a first server and a second server through a network, comprising:
designation means for designating, based on designation information transmitted from said first server for designating software corresponding to apparatus information of said information processing apparatus, the software, the designation information being produced based on first software information of the software including identification information of the software;
requesting means for requesting install information indicated by second software information, transmitted from said first server, of the software designated by said designation means to said second server; and
install means for installing the software based on the install information transmitted from said second server in response to the request of said requesting means.

16. An information processing method for an information processing apparatus connectable to a first server and a second server through a network, comprising:
a designation step of designating, based on designation information transmitted from said first server for designating software corresponding to apparatus information of said information processing apparatus, the software, the designation information being produced based on first software information of the software including identification information of the software;
a request step of requesting install information indicated by second software information, transmitted from said first server, of the software designated by the process at the designation step to said second server; and
an install step of installing the software based on the install information transmitted from said second server in response to the request by the process at the request step.

17. A program for an information processing apparatus connectable to a first server and a second server through a network, the program causing a computer to execute a processing including:
a designation controlling step of controlling designation, based on designation information transmitted from said first server for designating software corresponding to apparatus information of said information processing apparatus, of the software, the designation information being produced based on first software information of the software including identification information of the software;
a request controlling step of controlling the request to said second server for install information indicated by second software information, transmitted from said first server, of the software designated by the process at the designation controlling step; and
an install controlling step of controlling installation of the software based on the install information transmitted from said second server in response to the request by the process at the request controlling step.
